(19) United States
(12) Patent Application Publication
(10) Pub. No.: US 2026/0127488 A1
(43) Pub. Date: May 7, 2026

(54) TRAINING METHOD FOR MACHINE LEARNING MODEL AND HOST SYSTEM

(71) Applicant: PHISON ELECTRONICS CORP., Miaoli (TW)

(72) Inventors: Yu-Hao Wang, Pingtung County (TW); Szu-Wei Chen, New Taipei City (TW); Jian Ping Syu, Taichung City (TW); Hao-Zhi Lee, Miaoli (TW); An-Cheng Liu, Taipei City (TW)

(73) Assignee: PHISON ELECTRONICS CORP., Miaoli (TW)

(21) Appl. No.: 18/967,689

(22) Filed: Dec. 4, 2024

(30) Foreign Application Priority Data
Nov. 5, 2024 (TW) 113142309

(51) Int. Cl. G06N 20/00

(52) U.S. Cl. CPC G06N 20/00

(57) ABSTRACT

A training method for a machine learning model and a host system are provided. The host system includes a rewritable non-volatile memory module. The training method includes: executing a training process of the machine learning model, which includes, in an iteration at an epoch of the training process, storing transient data and backtracking data generated by the iteration in the rewritable non-volatile memory module; and in response to an abnormality occurring in the host system which causes an interruption in the iteration, reading the transient data and the backtracking data from the rewritable non-volatile memory module, determining a stage of the iteration based on the backtracking data, and resuming the stage according to the transient data.

### CROSS-REFERENCE TO RELATED APPLICATION

This application claims the priority benefit of Taiwan application serial no. 113142309, filed on Nov. 5, 2024. The entirety of the above-mentioned patent application is hereby incorporated by reference herein and made a part of this specification.

### BACKGROUND

### Technical Field

The disclosure relates to a training method for a machine learning model and a host system using a rewritable non-volatile memory module.

### Description of Related Art

As artificial intelligence technology develops rapidly, deep learning models are applied in more and more fields, especially in fields such as natural language processing, image recognition, and speech recognition. However, training these complex models involves a large amount of data, resulting in a very time-consuming training process. Generally, the training process of deep learning models is divided into multiple epochs, with each epoch representing a complete traversal of the training dataset. During the training process, to reduce the impact of an unexpected interruption on the training progress, a checkpoint is usually set at the end of each epoch. If the system experiences an interruption or failure, the model may recover from the last checkpoint and re-execute the current epoch, thereby eliminating the need to start the training from the beginning.

However, as the scale of datasets increases, the time required for each epoch also increases significantly. Even with the checkpoint mechanism, backtracking to the checkpoint and re-executing the epoch after an interruption still costs a considerable amount of time and computational resources. This problem is particularly prominent in the training of large datasets, especially when the model needs to iterate multiple times to achieve the desired accuracy. As a result, the loss in efficiency becomes more severe.

### SUMMARY

An embodiment of the disclosure provides a training method for a machine learning model, which is adapted for a host system. The host system includes a rewritable non-volatile memory module. The training method includes: executing a training process of the machine learning model, which includes, in an iteration at an epoch of the training process, storing transient data and backtracking data generated by the iteration in the rewritable non-volatile memory module; and in response to an abnormality occurring in the host system which causes an interruption in the iteration, reading the transient data and the backtracking data from the rewritable non-volatile memory module, determining a stage of the iteration based on the backtracking data, and resuming the stage according to the transient data.

In an embodiment of the disclosure, the iteration includes forward propagation, backward propagation, and an update stage. Storing the transient data and the backtracking data generated by the iteration in the rewritable non-volatile memory module includes: in response to the forward propagation being completed, obtaining an output of a neuron in the machine learning model, setting the transient data to include the output of the neuron, setting the backtracking data to indicate that the forward propagation has been completed, and writing the output of the neuron and the backtracking data to the rewritable non-volatile memory module.

In an embodiment of the disclosure, determining the stage of the iteration based on the backtracking data, and resuming the stage according to the transient data includes: setting the stage to the backward propagation according to the backtracking data; and reading the output of the neuron and a plurality of weights from the rewritable non-volatile memory module, and re-executing the backward propagation according to the output of the neuron and the weights.

In an embodiment of the disclosure, storing the transient data and the backtracking data generated by the iteration in the rewritable non-volatile memory module includes: in response to the backward propagation being completed, setting the transient data to include a gradient, setting the backtracking data to indicate that the backward propagation has been completed, and writing the gradient and the backtracking data to the rewritable non-volatile memory module.

In an embodiment of the disclosure, determining the stage of the iteration based on the backtracking data, and resuming the stage according to the transient data includes: setting the stage to the update stage according to the backtracking data; and reading the gradient and a plurality of weights from the rewritable non-volatile memory module, and re-executing the update stage according to the gradient and the weights.

In an embodiment of the disclosure, the machine learning model includes a plurality of layers, and storing the transient data and the backtracking data generated by the iteration in the rewritable non-volatile memory module further includes: after updating a first layer of the layers in the update stage, setting the transient data to further include a plurality of updated weights of the first layer, setting the backtracking data to indicate that the first layer has been updated, and writing the updated weights and the backtracking data to the rewritable non-volatile memory module.

In an embodiment of the disclosure, determining the stage of the iteration based on the backtracking data, and resuming the stage according to the transient data includes: setting the stage to a second layer of the layers according to the backtracking data, in which the second layer is different from the first layer; and reading the gradient and a plurality of weights of the second layer from the rewritable non-volatile memory module, and updating the weights of the second layer according to the gradient.

In an embodiment of the disclosure, storing the transient data and the backtracking data generated by the iteration in the rewritable non-volatile memory module includes: in response to the update stage being completed, setting the transient data to include a plurality of updated weights and an updated optimization parameter, setting the backtracking data to indicate that the backward propagation has been completed, and writing the updated weights, the updated optimization parameter, and the backtracking data to the rewritable non-volatile memory module.

In an embodiment of the disclosure, the training method further includes: in response to forward propagation of a subsequent iteration being interrupted, reading the updated weights and the updated optimization parameter from the rewritable non-volatile memory module; and re-executing the subsequent iteration according to the updated weights and the updated optimization parameter, in which the subsequent iteration is executed after the iteration.

From another perspective, an embodiment of the disclosure provides a host system, which includes a rewritable non-volatile memory module and a processor. The processor is electrically connected to the rewritable non-volatile memory module for: executing a training process of a machine learning model, which includes, in an iteration at an epoch of the training process, storing transient data and backtracking data generated by the iteration in the rewritable non-volatile memory module; and in response to an abnormality occurring in the host system which causes an interruption in the iteration, reading the transient data and the backtracking data from the rewritable non-volatile memory module, determining a stage of the iteration based on the backtracking data, and resuming the stage according to the transient data.

To make the foregoing features and advantages of the disclosure more understandable, exemplary embodiments will be described in detail below with reference to the accompanying drawings.

### BRIEF DESCRIPTION OF THE DRAWINGS

FIG. 1 is a schematic diagram illustrating the host system and the input/output (I/O) device according to an exemplary embodiment of the disclosure.

FIG. 2 is a schematic diagram illustrating the host system, the memory storage device, and the I/O device according to an exemplary embodiment of the disclosure.

FIG. 3 is a schematic diagram illustrating the memory storage device according to an exemplary embodiment of the disclosure.

FIG. 4 is a schematic diagram illustrating the training process according to an embodiment.

FIG. 5A is a schematic diagram illustrating storing the transient data in one iteration according to an embodiment.

FIG. 5B is a schematic diagram illustrating the backtracking data according to an embodiment.

FIG. 6 is a schematic diagram illustrating the backtracking when backward propagation is interrupted according to an embodiment.

FIG. 7 is a schematic diagram illustrating the backtracking of one layer in the update stage according to an embodiment.

FIG. 8 is a flowchart illustrating the training method for a machine learning model according to an embodiment.

### DESCRIPTION OF THE EMBODIMENTS

Some embodiments of the disclosure will be described in detail below with reference to the accompanying drawings. Regarding the reference numerals used in the following description, identical reference numerals in different drawings will be considered as representing identical or similar elements. These embodiments are only a part of the disclosure and do not disclose all possible implementations of the disclosure. More precisely, these embodiments are merely examples of the system and method in the claims of the disclosure.

Terms such as “first” and “second” used in this specification do not particularly indicate the order or sequence, but are merely used to distinguish elements or operations described with the same technical terms from each other.

Typically, a memory storage device (also referred to as a memory storage system) includes a rewritable non-volatile memory module and a controller (also referred to as a control circuit). The memory storage device may be used together with a host system to enable the host system to write data to the memory storage device or read data from the memory storage device.

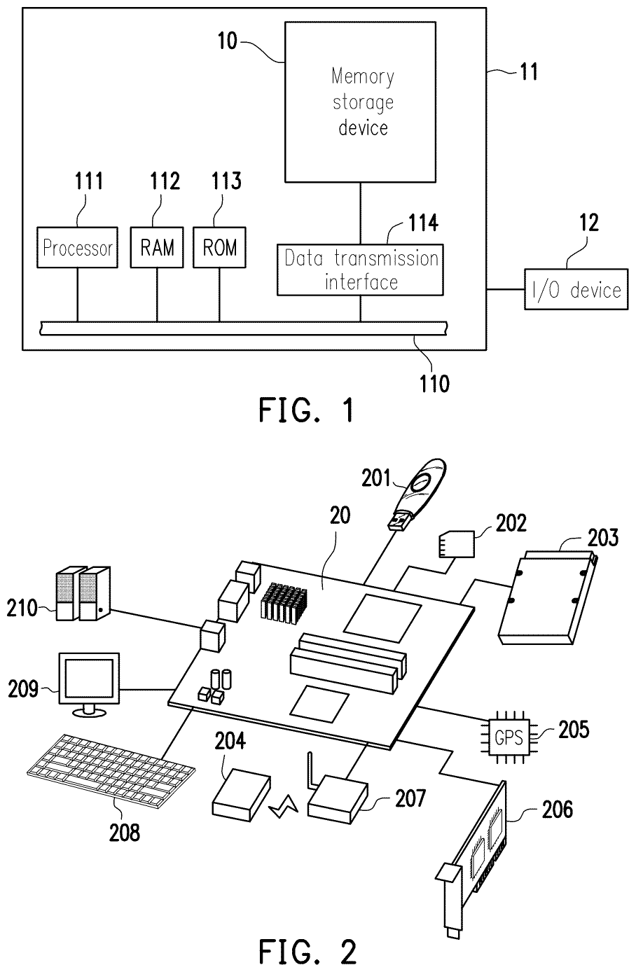

FIG. 1 is a schematic diagram illustrating the host system and the input/output (I/O) device according to an exemplary embodiment of the disclosure. FIG. 2 is a schematic diagram illustrating the host system, the memory storage device, and the I/O device according to an exemplary embodiment of the disclosure.

Referring to FIG. 1 and FIG. 2, a host system 11 is a computer system, which may be a desktop computer, a server, a distributed system, a laptop, or the like, and the disclosure is not limited thereto. The host system 11 includes a processor 111, a random access memory (RAM) 112, a read only memory (ROM) 113, and a data transmission interface 114. The processor 111, the random access memory 112, the read only memory 113, and the data transmission interface 114 may be coupled to a system bus 110. The processor 111 may be a graphic processing unit (GPU), a tensor processing unit (TPU), a neural processing unit (NPU), a central processing unit, or the like. In some embodiments, a memory may also be included in the processor 111.

In an exemplary embodiment, the processor 111 may be coupled to a memory storage device 10 via the data transmission interface 114. For instance, the processor 111 may store data in the memory storage device 10 or read data from the memory storage device 10 via the data transmission interface 114. Furthermore, the host system 11 may be coupled to an I/O device 12 via the system bus 110. For example, the host system 11 may transmit output signals to the I/O device 12 or receive input signals from the I/O device 12 via the system bus 110. In other embodiments, the processor 111 may also be electrically connected to the memory storage device 10 via a dedicated data transmission interface 114, rather than via the system bus 110.

In an exemplary embodiment, the processor 111, the random access memory 112, the read only memory 113, and the data transmission interface 114 may be disposed on a motherboard 20 of the host system 11. The number of the data transmission interfaces 114 may be one or more. Through the data transmission interface 114, the motherboard 20 may be coupled to the memory storage device 10 in a wired or wireless manner.

In an exemplary embodiment, the memory storage device 10 may be, for instance, a USB flash drive 201, a memory card 202, or a solid state drive (SSD) 203. In some embodiments, the memory storage device 10 may be disposed outside the host system 11 as a wireless memory storage device 204. The wireless memory storage device 204 may be, for example, a near field communication (NFC) memory storage device, a WiFi memory storage device, a Bluetooth memory storage device, or a low-power Bluetooth memory storage device (for example, iBeacon), which are memory storage devices based on various wireless communication technologies. Moreover, the motherboard 20 may also be coupled via the system bus 110 to various I/O devices such as a global positioning system (GPS) module 205, a network interface card 206, a wireless transmission device 207, a keyboard 208, a screen 209, and a speaker 210. For instance, in an exemplary embodiment, the motherboard 20 may access the wireless memory storage device 204 through the wireless transmission device 207.

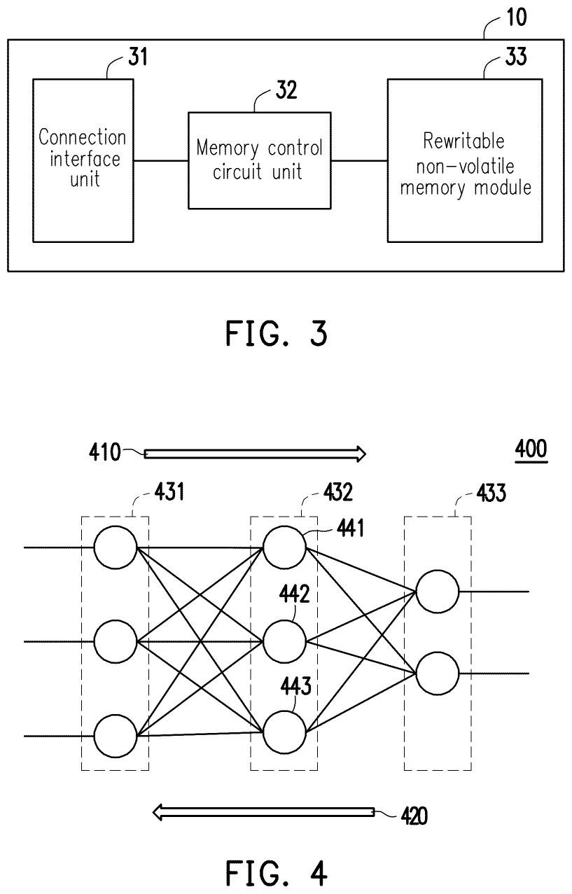

FIG. 3 is a schematic diagram illustrating the memory storage device according to an exemplary embodiment of the disclosure. Referring to FIG. 3, the memory storage device 10 includes a connection interface unit 31, a memory control circuit unit 32, and a rewritable non-volatile memory module 33.

The connection interface unit 31 is configured to couple to the processor 111. The memory storage device 10 may communicate with the processor 111 via the connection interface unit 31. In an exemplary embodiment, the connection interface unit 31 is compatible with the Peripheral Component Interconnect Express (PCI Express) standard. In an exemplary embodiment, the connection interface unit 31 may also comply with the Serial Advanced Technology Attachment (SATA) standard, Parallel Advanced Technology Attachment (PATA) standard, Institute of Electrical and Electronic Engineers (IEEE) 1394 standard, Universal Serial Bus (USB) standard, SD interface standard, Ultra High Speed-I (UHS-I) interface standard, Ultra High Speed-II (UHS-II) interface standard, Memory Stick (MS) interface standard, MCP interface standard, MMC interface standard, eMMC interface standard, Universal Flash Storage (UFS) interface standard, eMCP interface standard, CF interface standard, Integrated Device Electronics (IDE) standard, or other suitable standards. The connection interface unit 31 may be packaged with the memory control circuit unit 32 in one chip, or the connection interface unit 31 may be set outside a chip containing the memory control circuit unit 32.

The memory control circuit unit 32 is coupled to the connection interface unit 31 and the rewritable non-volatile memory module 33. The memory control circuit unit 32 is configured to execute multiple logic gates or control instructions implemented in hardware or firmware form and to perform operations such as writing, reading, and erasing data in the rewritable non-volatile memory module 33 according to instructions of the processor 111.

The rewritable non-volatile memory module 33 is configured to store data written by the processor 111. The rewritable non-volatile memory module 33 may include a single level cell (SLC) NAND flash memory module (that is, a flash memory module that can store 1 bit in one memory cell), a multi level cell (MLC) NAND flash memory module (that is, a flash memory module that can store 2 bits in one memory cell), a triple level cell (TLC) NAND flash memory module (that is, a flash memory module that can store 3 bits in one memory cell), a quad level cell (QLC) NAND flash memory module (that is, a flash memory module that can store 4 bits in one memory cell), other flash memory modules, or other memory modules with similar characteristics.

Each memory cell in the rewritable non-volatile memory module 33 stores one or more bits by changing the voltage (hereinafter also referred to as the threshold voltage). Specifically, each memory cell has a charge trapping layer between the control gate and the channel. Applying a write voltage to the control gate can change the number of electrons in the charge trapping layer, thereby changing the threshold voltage of the memory cell. This operation of changing the threshold voltage of the memory cell is also referred to as “writing data to the memory cell” or “programming the memory cell.” With the change in threshold voltage, each memory cell in the rewritable non-volatile memory module 33 has multiple storage states. The storage state of a memory cell can be determined by applying a read voltage, thereby obtaining the one or more bits stored in this memory cell.

In an exemplary embodiment, the memory cells of the rewritable non-volatile memory module 33 may constitute multiple physical programming units, and these physical programming units may constitute multiple physical erase units. Specifically, memory cells on the same word line may form one or more physical programming units. If each memory cell can store 2 or more bits, the physical programming units on the same word line may be classified into at least lower physical programming units and upper physical programming units. For example, the least significant bit (LSB) of a memory cell belongs to the lower physical programming unit, and the most significant bit (MSB) of a memory cell belongs to the upper physical programming unit. Generally, in an MLC NAND flash memory, the write speed of the lower physical programming unit is greater than the write speed of the upper physical programming unit, and/or the reliability of the lower physical programming unit is higher than the reliability of the upper physical programming unit.

In some embodiments, the rewritable non-volatile memory module 33 uses the lower physical programming units or single level cells to store data written by the processor 111. The processor 111 executes a training method for a machine learning model, and the rewritable non-volatile memory module 33 serves as a cache for the processor 111. Transient data generated during a training process of the machine learning model is stored in the rewritable non-volatile memory module 33. Additionally, the rewritable non-volatile memory module 33 also stores backtracking data, which is used to indicate to which stage the training process has been executed. When a power outage or other abnormalities cause an interruption in the training process, the training process can be re-executed based on the backtracking data and the transient data. In embodiments using lower physical programming units or single level cells, the drive writes per day (DWPD) of the rewritable non-volatile memory module 33 is relatively large, thus allowing frequent writes. More backtracking points may be set in the training process to avoid the loss of substantial computational resources when the training process is interrupted.

FIG. 4 is a schematic diagram illustrating the training process according to an embodiment. The machine learning model to be trained here is a neural network 400. The training of the neural network includes forward propagation 410, backward propagation 420, and an update stage. Completion of the three stages is called one iteration. Multiple training samples can be trained in one iteration, and these training samples are called a batch. Completion of the training for all samples is called an epoch. For example, if a batch includes 50 samples and there are 70,000 samples in total, 1,400 iterations are required to complete one epoch.

The neural network 400 includes multiple layers 431 to 433, with each layer including multiple neurons (for example, neurons 441 to 443). Each neuron includes multiple inputs and at least one output, with each input corresponding to a weight. During the forward propagation 410, the inputs are multiplied by these weights, and then summed, which may be represented by the following Mathematical Equation 1.

$${z}_{j} = {\sum }_{i} {x}_{i} {w}_{i , j} + {b}_{j} \qquad [ Mathematical Equation 1 ]$$

where w_{i,j} represents the i-th weight in the j-th neuron, xᵢ represents the i-th input, and bⱼ represents the bias of the j-th neuron. The value zⱼ calculated by Mathematical Equation 1 is then processed through an activation function to obtain the output of this neuron, which is also called an activation, as shown in the following Mathematical Equation 2.

$${a}_{j} = f ( {z}_{i} ) \qquad [ Mathematical Equation 2 ]$$

where aⱼ is the output of the activation function (also the output of the neuron). f( ) is the activation function, which may be any non-linear function. The output layer 433 of the neural network 400 calculates one or more outputs, and a loss L can be calculated through a loss function and the ground truth. During the backward propagation, the gradient of the loss with respect to the weight is calculated, and the update of each weight may be represented by the following Mathematical Equation 3.

$${w}_{i , j} = {w}_{i , j} - γ \frac{dL}{d {w}_{i , j}} \qquad [ Mathematical Equation 3 ]$$

where γ is the learning rate.

$$\frac{dL}{{dw}_{i , j}}$$

is called the gradient. Based on the chain rule of calculus, the gradient

$$\frac{dL}{{dw}_{i , j}}$$

may be decomposed into multiple gradients, including, for example, the gradient of the loss with respect to the output of the neuron, etc. For simplification, these details will not be elaborated here. During the backward propagation 420, the gradient of the last layer is calculated first, then the gradient of the second-to-last layer is calculated, and so on, and the gradient of the first layer is calculated last. The update stage is performed according to Mathematical Equation 3 after calculating the gradients of all layers.

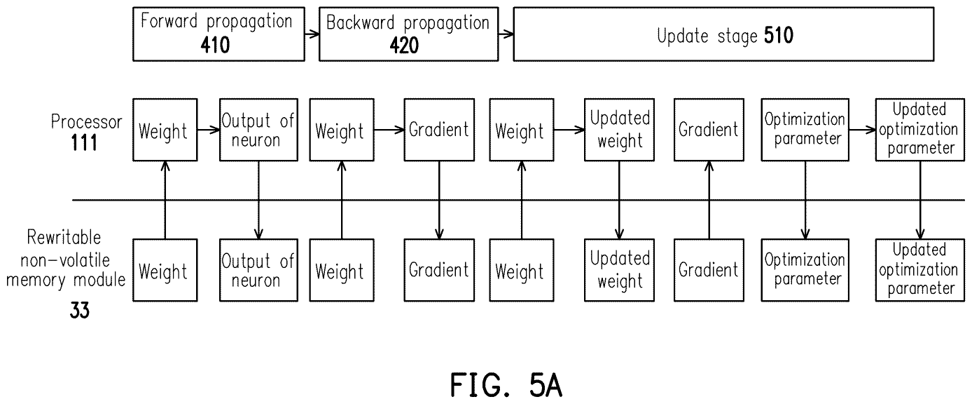

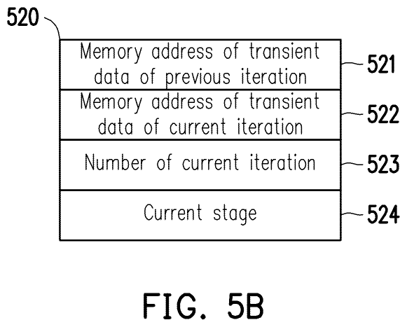

In a certain iteration at an epoch during the training process, the transient data and the backtracking data generated by this iteration are stored in the rewritable non-volatile memory module 33. As mentioned above, one iteration includes three stages: forward propagation, backward propagation, and update stage, with each stage generating different transient data. FIG. 5A is a schematic diagram illustrating storing the transient data in one iteration according to an embodiment. Referring to FIG. 5A, during the forward propagation 410, the processor 111 reads the weights of the neural network from the rewritable non-volatile memory module 33. The outputs of the neurons can be calculated based on these weights and the input of the model. After the forward propagation is completed, the output of the neural network and the outputs of all neurons in all layers may be written to the rewritable non-volatile memory module 33. In other words, the transient data at this time includes the output of the neural network and the outputs of the neurons. In some embodiments, the transient data may also include the input of each layer. On the other hand, the processor 111 may also set backtracking data indicating that the forward propagation 410 has been completed, and then write the backtracking data to the rewritable non-volatile memory module 33. In some embodiments, the backtracking data also includes the memory address of the transient data.

During the backward propagation 420, the weights of the neural network are read from the rewritable non-volatile memory module 33, and then the gradient

$$\frac{dL}{{dw}_{i , j}}$$

of each weight is calculated according to these weights, the output of the neural network, and the outputs of the neurons in each layer. After the backward propagation 420 is completed, the gradient

$$\frac{dL}{{dw}_{i , j}}$$

corresponding to each weight can be written to the rewritable non-volatile memory module 33. In other words, the transient data at this time includes the gradient

$$\frac{dL}{{dw}_{i , j}} .$$

In addition, the backtracking data may also be set to indicate that the backward propagation 420 has been completed. In some embodiments, the backtracking data also includes the memory address of the gradient.

During the update stage 510, the weights, gradients, and optimization parameters are read from the rewritable non-volatile memory module 33. The optimization parameters may include, for example, the above-mentioned learning rate, momentum, etc., but the disclosure is not limited thereto. The weights may be updated according to Mathematical Equation 3 mentioned above to generate corresponding updated weights, and some of the optimization parameters may also be updated (for example, the momentum may be updated) to generate updated optimization parameters. After the update stage 510 is completed, the updated weights and the updated optimization parameters may be written to the rewritable non-volatile memory module 33. In other words, the transient data at this stage includes the updated weights and the updated optimization parameters. Additionally, the backtracking data may be set to indicate that the backward propagation 420 has been completed. In some embodiments, the backtracking data may also include the memory addresses of the updated weights and the updated optimization parameters.

FIG. 5B is a schematic diagram illustrating the backtracking data according to an embodiment. Referring to FIG. 5B, in this embodiment, the backtracking data includes a mapping table 520, which includes fields 521 to 524. The field 521 records the memory address of the transient data of the previous iteration. The field 522 records the memory address of the transient data of the current iteration. The field 523 records the number of the current iteration. The field 524 records the current stage. If the system has a power outage, the iteration that was being executed before the power outage can be determined from the field 523 of the mapping table 520, and the stage (forward propagation, backward propagation, or update stage) that was being executed before the power outage can be determined from the field 524. The required transient data may be retrieved from the rewritable non-volatile memory module 33 based on the field 521 and the field 522.

Through the above approach, the corresponding transient data and backtracking data are written to the rewritable non-volatile memory module 33 in each stage of the iteration. If an abnormality occurs in the host system 11 which causes an interruption in an iteration, the transient data and the backtracking data may be read from the rewritable non-volatile memory module 33. A stage of the iteration may be determined based on the backtracking data, and this stage may be re-executed according to the transient data.

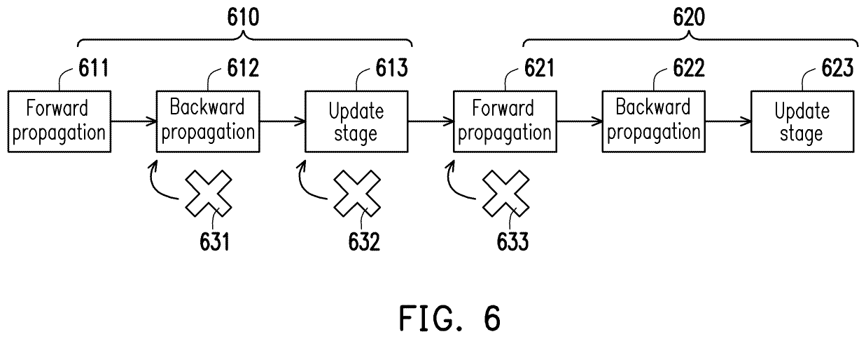

Specifically, FIG. 6 is a schematic diagram illustrating the backtracking when the backward propagation is interrupted according to an embodiment. Referring to FIG. 5 and FIG. 6, FIG. 6 illustrates two iterations 610 and 620 of the training process. The iteration 620 is executed after the iteration 610, and therefore, the iteration 620 is also referred to as a subsequent iteration. The iteration 610 includes forward propagation 611, backward propagation 612, and an update stage 613. The iteration 620 includes forward propagation 621, backward propagation 622, and an update stage 623.

Referring to an interruption 631, if an abnormality occurs in the host system 11 during the backward propagation 612 and causes the backward propagation 612 to be interrupted, the backtracking data may be read from the rewritable non-volatile memory module 33, followed by reading the transient data stored upon completion of the forward propagation 611. According to this backtracking data, it is determined that the forward propagation 611 has been completed while the backward propagation 612 has not been completed. Therefore, the stage that needs to be re-executed is the backward propagation 612. Subsequently, the outputs of the neurons and the input of each layer may be obtained from the transient data, and the weights of the neural network may also be read from the rewritable non-volatile memory module 33. The backward propagation 612 may be re-executed based on the outputs of the neurons, the input of each layer, and the weights.

Referring to an interruption 632, if an abnormality occurs in the host system 11 during the update stage 613 and causes the update stage 613 to be interrupted, the backtracking data may be read from the rewritable non-volatile memory module 33, followed by reading the transient data stored upon completion of the backward propagation 612. According to this backtracking data, it is determined that the backward propagation 612 has been completed while the update stage 613 has not been completed. Therefore, the stage that needs to be re-executed is the update stage 613. Subsequently, the gradients and the weights of the neural network may be obtained from the transient data. The update stage 613 may be re-executed based on these gradients and weights.

Referring to an interruption 633, if the forward propagation 621 of the iteration 620 is interrupted, the backtracking data may be read from the rewritable non-volatile memory module 33, followed by reading the transient data stored upon completion of the update stage 613. According to this backtracking data, it is determined that the update stage 613 has been completed while the forward propagation 621 has not been completed. Therefore, the stage that needs to be re-executed is the forward propagation 621. Subsequently, the updated weights and the updated optimization parameters may be obtained from the transient data. The forward propagation 621 of the subsequent iteration 620 may be re-executed based on these updated weights and updated optimization parameters.

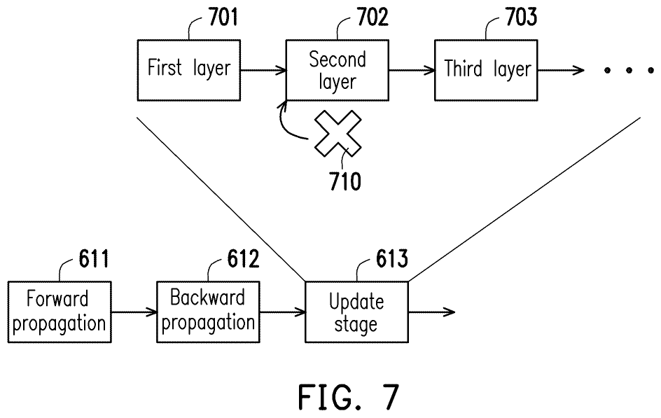

During the update stage, the updates for the weights in each layer are independent of each other, which means that the update of one layer does not depend on the update of another layer. Therefore, in some embodiments, when the update stage is interrupted, the execution may begin from the layer that has not been completed, without the need to execute layers that have already been updated. FIG. 7 is a schematic diagram illustrating the backtracking of one layer in the update stage according to an embodiment. Referring to FIG. 7, the update stage 613 includes updates of a first layer 701, a second layer 702, a third layer 703, and so on. When the update of the first layer 701 is completed, the transient data may be set to include multiple updated weights of the first layer 701, and these updated weights may be written to the rewritable non-volatile memory module 33. Additionally, the backtracking data may be set to indicate that the update of the first layer has been completed.

Referring to an interruption 710, if the update stage 613 is interrupted due to a system abnormality while updating the second layer 702, the backtracking data may be read from the rewritable non-volatile memory module 33, followed by reading the corresponding transient data. According to the backtracking data, it is determined that the update of the first layer 701 has been completed. Therefore, the update of the second layer 702 needs to be re-executed. Subsequently, the gradients may be read from the transient data, and the weights of the second layer may also be read from the rewritable non-volatile memory module 33. The weights of the second layer 702 may be updated based on the gradients. In this way, layers that have already been updated do not need to be re-executed.

In some embodiments, the backtracking in the forward propagation 611 and the backward propagation 612 is also performed with layers as the minimum granularity. During the forward propagation 611, when the computation for each layer is completed, data such as the input of that layer and the outputs of neurons may be added to the transient data, and the transient data may be written to the rewritable non-volatile memory module 33. During the backward propagation 612, when the computation for each layer is completed, data such as the gradients of each layer may be added to the transient data, and the transient data may be written to the rewritable non-volatile memory module 33.

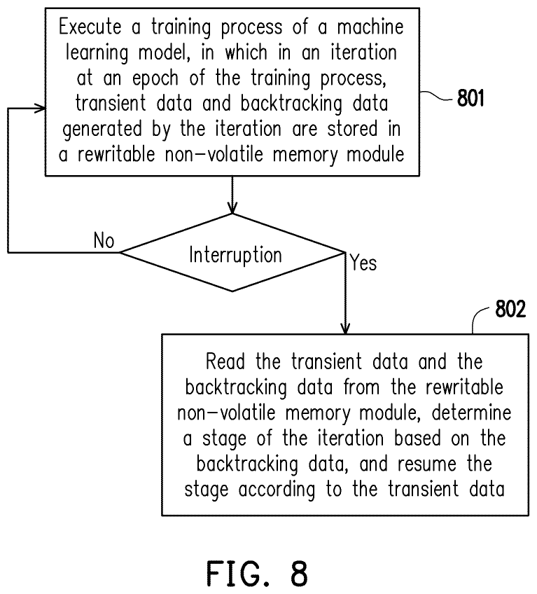

FIG. 8 is a flowchart illustrating a training method for a machine learning model according to an embodiment. Referring to FIG. 8, in step 801, a training process of the machine learning model is executed, in which in an iteration at an epoch of the training process, transient data and backtracking data generated by the iteration are stored in a rewritable non-volatile memory module. In response to the system not experiencing any abnormality which causes an interruption in the training process, the process returns to step 801 to continue with the next iteration. In response to an abnormality occurring in the host system which causes an interruption in the iteration, step 802 is executed to read the transient data and the backtracking data from the rewritable non-volatile memory module, determine a stage of the iteration based on the backtracking data, and resume the stage according to the transient data. The steps in FIG. 8 have been described in detail above, so the details will not be repeated here. It is worth noting that each step in FIG. 8 may be implemented as multiple program codes or circuits, and the disclosure is not limited in this regard. Furthermore, the method of FIG. 8 may be used in conjunction with the above embodiments or used independently. In other words, other steps may be added between the steps in FIG. 8.

In the host system and the training method described above, the transient data generated in the iteration may be written to the rewritable non-volatile memory module. Thus, when an interruption of the training process occurs, backtracking may be performed with each stage in the iteration as the granularity. In some embodiments, backtracking may also be performed with layers as the granularity, thereby avoiding waste of computational resources.

Although the disclosure has been described above with reference to the embodiments, they are not intended to limit the disclosure. Any person having ordinary knowledge in the art may make modifications and changes without departing from the spirit and scope of the disclosure. Therefore, the scope of protection of the disclosure shall be defined by the appended claims.

What is claimed is:

1. A training method for a machine learning model, adapted for a host system that comprises a rewritable non-volatile memory module, the training method comprising:
executing a training process of the machine learning model, which comprises, in an iteration at an epoch of the training process, storing transient data and backtracking data generated by the iteration in the rewritable non-volatile memory module; and
in response to an abnormality occurring in the host system which causes an interruption in the iteration, reading the transient data and the backtracking data from the rewritable non-volatile memory module, determining a stage of the iteration based on the backtracking data, and resuming the stage according to the transient data.

2. The training method according to claim 1, wherein the iteration comprises forward propagation, backward propagation, and an update stage, wherein storing the transient data and the backtracking data generated by the iteration in the rewritable non-volatile memory module comprises:
in response to the forward propagation being completed, obtaining an output of a neuron in the machine learning model, setting the transient data to include the output of the neuron, setting the backtracking data to indicate that the forward propagation has been completed, and writing the output of the neuron and the backtracking data to the rewritable non-volatile memory module.

3. The training method according to claim 2, wherein determining the stage of the iteration based on the backtracking data, and resuming the stage according to the transient data comprises:
setting the stage to the backward propagation according to the backtracking data; and
reading the output of the neuron and a plurality of weights from the rewritable non-volatile memory module, and re-executing the backward propagation according to the output of the neuron and the weights.

4. The training method according to claim 1, wherein the iteration comprises forward propagation, backward propagation, and an update stage, wherein storing the transient data and the backtracking data generated by the iteration in the rewritable non-volatile memory module comprises:
in response to the backward propagation being completed, setting the transient data to include a gradient, setting the backtracking data to indicate that the backward propagation has been completed, and writing the gradient and the backtracking data to the rewritable non-volatile memory module.

5. The training method according to claim 4, wherein determining the stage of the iteration based on the backtracking data, and resuming the stage according to the transient data comprises:
setting the stage to the update stage according to the backtracking data; and
reading the gradient and a plurality of weights from the rewritable non-volatile memory module, and re-executing the update stage according to the gradient and the weights.

6. The training method according to claim 4, wherein the machine learning model comprises a plurality of layers, and storing the transient data and the backtracking data generated by the iteration in the rewritable non-volatile memory module further comprises:
after updating a first layer of the layers in the update stage, setting the transient data to further include a plurality of updated weights of the first layer, setting the backtracking data to indicate that the first layer has been updated, and writing the updated weights and the backtracking data to the rewritable non-volatile memory module.

7. The training method according to claim 6, wherein determining the stage of the iteration based on the backtracking data, and resuming the stage according to the transient data comprises:
setting the stage to a second layer of the layers according to the backtracking data, wherein the second layer is different from the first layer; and
reading the gradient and a plurality of weights of the second layer from the rewritable non-volatile memory module, and updating the weights of the second layer according to the gradient.

8. The training method according to claim 1, wherein the iteration comprises forward propagation, backward propagation, and an update stage, wherein storing the transient data and the backtracking data generated by the iteration in the rewritable non-volatile memory module comprises:
in response to the update stage being completed, setting the transient data to include a plurality of updated weights and an updated optimization parameter, setting the backtracking data to indicate that the update stage has been completed, and writing the updated weights, the updated optimization parameter, and the backtracking data to the rewritable non-volatile memory module.

9. The training method according to claim 8, further comprising:
in response to forward propagation of a subsequent iteration being interrupted, reading the updated weights and the updated optimization parameter from the rewritable non-volatile memory module; and
re-executing the subsequent iteration according to the updated weights and the updated optimization parameter, wherein the subsequent iteration is executed after the iteration.

10. A host system, comprising:
a rewritable non-volatile memory module; and
a processor electrically connected to the rewritable non-volatile memory module for:
executing a training process of a machine learning model, which comprises, in an iteration at an epoch of the training process, storing transient data and backtracking data generated by the iteration in the rewritable non-volatile memory module; and
in response to an abnormality occurring in the host system which causes an interruption in the iteration, reading the transient data and the backtracking data from the rewritable non-volatile memory module, determining a stage of the iteration based on the backtracking data, and resuming the stage according to the transient data.

11. The host system according to claim 10, wherein the iteration comprises forward propagation, backward propagation, and an update stage, wherein storing the transient data and the backtracking data generated by the iteration in the rewritable non-volatile memory module comprises:
in response to the forward propagation being completed, obtaining an output of a neuron in the machine learning model, setting the transient data to include the output of the neuron, setting the backtracking data to indicate that the forward propagation has been completed, and writing the output of the neuron and the backtracking data to the rewritable non-volatile memory module.

12. The host system according to claim 11, wherein determining the stage of the iteration based on the backtracking data, and resuming the stage according to the transient data comprises:
setting the stage to the backward propagation according to the backtracking data; and
reading the output of the neuron and a plurality of weights from the rewritable non-volatile memory module, and re-executing the backward propagation according to the output of the neuron and the weights.

13. The host system according to claim 10, wherein the iteration comprises forward propagation, backward propagation, and an update stage, wherein storing the transient data and the backtracking data generated by the iteration in the rewritable non-volatile memory module comprises:
in response to the backward propagation being completed, setting the transient data to include a gradient, setting the backtracking data to indicate that the backward propagation has been completed, and writing the gradient and the backtracking data to the rewritable non-volatile memory module.

14. The host system according to claim 13, wherein determining the stage of the iteration based on the backtracking data, and resuming the stage according to the transient data comprises:
setting the stage to the update stage according to the backtracking data; and
reading the gradient and a plurality of weights from the rewritable non-volatile memory module, and re-executing the update stage according to the gradient and the weights.

15. The host system according to claim 13, wherein the machine learning model comprises a plurality of layers, and storing the transient data and the backtracking data generated by the iteration in the rewritable non-volatile memory module further comprises:
after updating a first layer of the layers in the update stage, setting the transient data to further include a plurality of updated weights of the first layer, setting the backtracking data to indicate that the first layer has been updated, and writing the updated weights and the backtracking data to the rewritable non-volatile memory module.

16. The host system according to claim 15, wherein determining the stage of the iteration based on the backtracking data, and resuming the stage according to the transient data comprises:
setting the stage to a second layer of the layers according to the backtracking data, wherein the second layer is different from the first layer; and
reading the gradient and a plurality of weights of the second layer from the rewritable non-volatile memory module, and updating the weights of the second layer according to the gradient.

17. The host system according to claim 10, wherein the iteration comprises forward propagation, backward propagation, and an update stage, wherein storing the transient data and the backtracking data generated by the iteration in the rewritable non-volatile memory module comprises:
in response to the update stage being completed, setting the transient data to include a plurality of updated weights and an updated optimization parameter, setting the backtracking data to indicate that the update stage has been completed, and writing the updated weights, the updated optimization parameter, and the backtracking data to the rewritable non-volatile memory module.

18. The host system according to claim 17, wherein the processor further:
in response to forward propagation of a subsequent iteration being interrupted, reads the updated weights and the updated optimization parameter from the rewritable non-volatile memory module; and
re-executes the subsequent iteration according to the updated weights and the updated optimization parameter, wherein the subsequent iteration is executed after the iteration.
